(19) United States
(12) Patent Application Publication
(10) Pub. No.: US 2026/0037561 A1
(43) Pub. Date: Feb. 5, 2026

(54) MANAGING EMBEDDINGS AND TEXT FOR ENHANCED NATURAL LANGUAGE UNDERSTANDING

(71) Applicants: Arun Kwangil IYENGAR, Yorktown Heights, NY (US); Ashish KUNDU, Milpitas, CA (US)

(72) Inventors: Arun Kwangil IYENGAR, Yorktown Heights, NY (US); Ashish KUNDU, Milpitas, CA (US)

(21) Appl. No.: 18/794,265

(22) Filed: Aug. 5, 2024

(51) Int. Cl. G06F 16/33; G06F 16/93

(52) U.S. Cl. CPC G06F 16/3344; G06F 16/93

(57) ABSTRACT

In one embodiment, a method for managing embeddings and text for enhanced natural language understanding includes dividing, by a process, a corpus of one or more documents into a first plurality of fragments based on a first threshold size for a first large language model and computing, by the process, a first set of embeddings using the first large language model to analyze the first plurality of fragments. The method further includes dividing, by the process, the corpus of one or more documents into a second plurality of fragments based on a second threshold size for a second large language model and computing, by the process, a second set of embeddings using the second large language model to analyze the second plurality of fragments.

### TECHNICAL FIELD

The present disclosure relates generally to computer networks, and, more particularly, to managing embeddings and text for enhanced natural language understanding.

### BACKGROUND

Recent breakthroughs in large language models (LLMs), such as ChatGPT and GPT-4, represent new opportunities across a wide spectrum of industries. Indeed, the ability of these models to follow instructions now allow for interactions with tools (also called plugins) that are able to perform tasks such as searching the web, executing code, etc. In addition, LLMs are also able to interact with human users in a conversational manner to provide answers to highly technical and complex questions.

To enhance the performance of an LLM-based system, techniques such as retrieval augmented generation (RAG) have been developed. In general, RAG uses whereby different documents to enhance the input prompt from the user to, for example, add additional context to it. Typically, this is done by converting a documents or documents and the prompt into a single set of embeddings, and then performing a match to add the most relevant context to the prompt for input to the LLM.

However, these approaches may operate at a fixed degree of granularity, due to the amount of context available for addition to the prompt being provided at a fixed degree of granularity. In addition, the match between the document embeddings and that of the prompt is generally made based on their vector similarities according to a fixed metric. This can lead to scenarios where LLM systems may be relatively inflexible and therefore may not allow for actual control over their RAG mechanisms.

### BRIEF DESCRIPTION OF THE DRA WINGS

The embodiments herein may be better understood by referring to the following description in conjunction with the accompanying drawings in which like reference numerals indicate identically or functionally similar elements, of which:

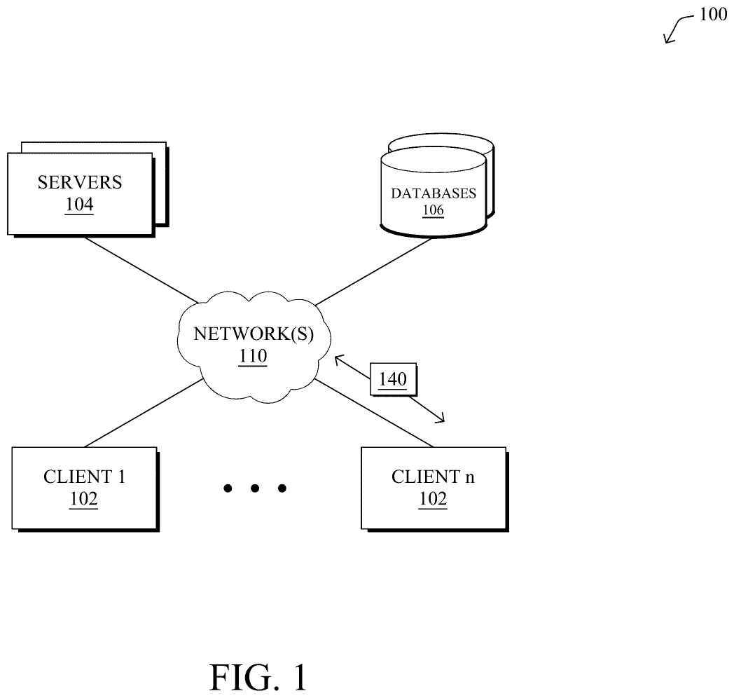

FIG. 1 illustrates an example computing system;

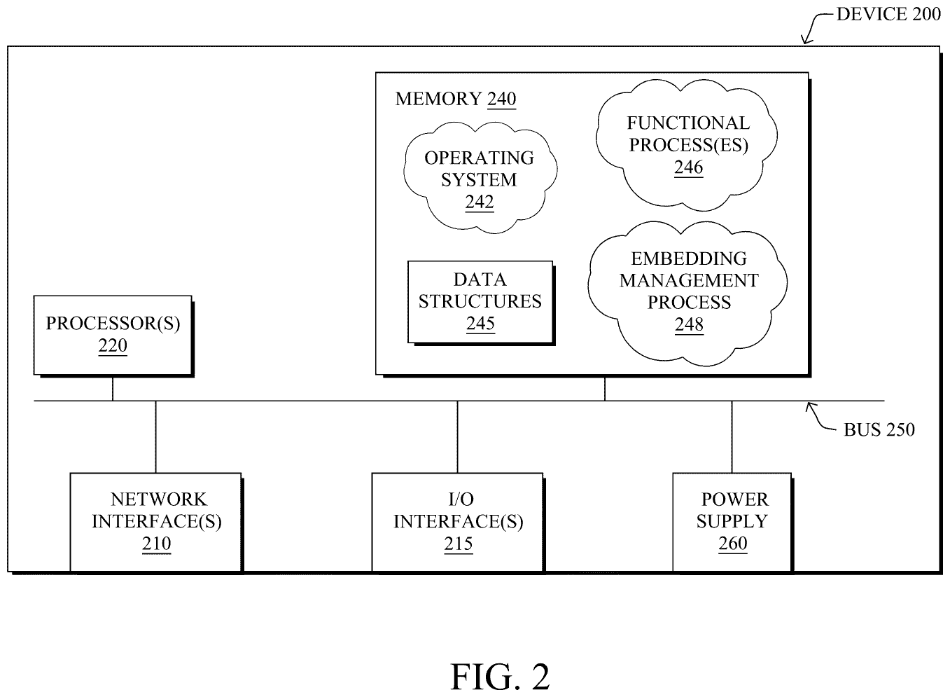

FIG. 2 illustrates an example network device/node;

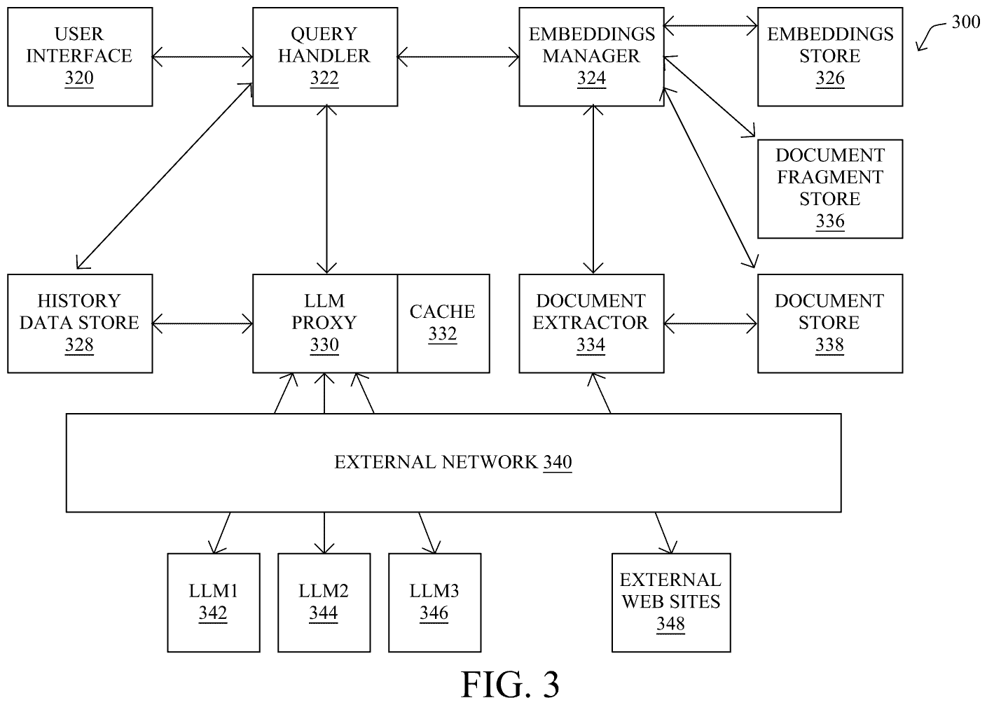

FIG. 3 illustrates an example system for managing embeddings and text for enhanced natural language understanding in accordance with the present disclosure;

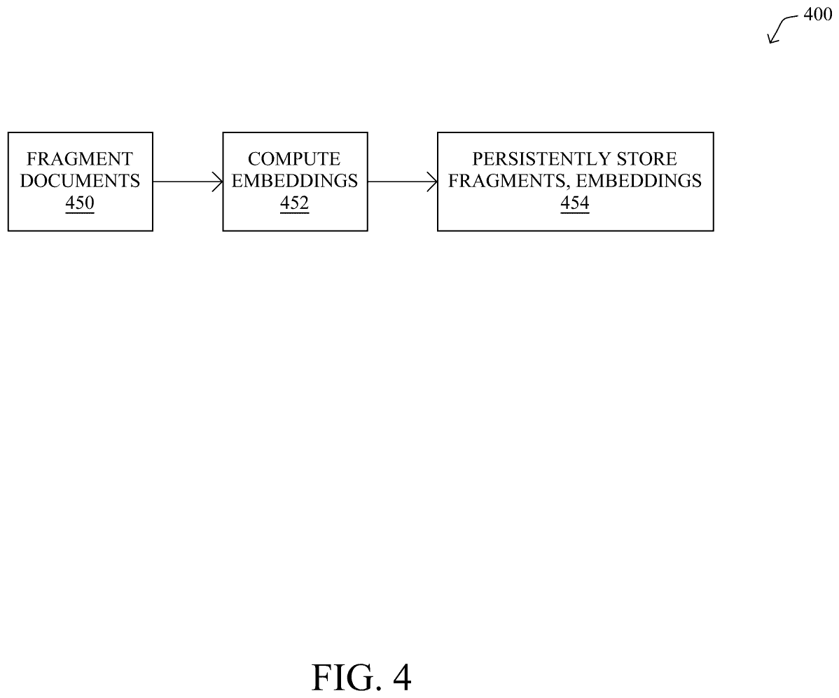

FIG. 4 illustrates an example flow for managing documents and embeddings in accordance with the present disclosure;

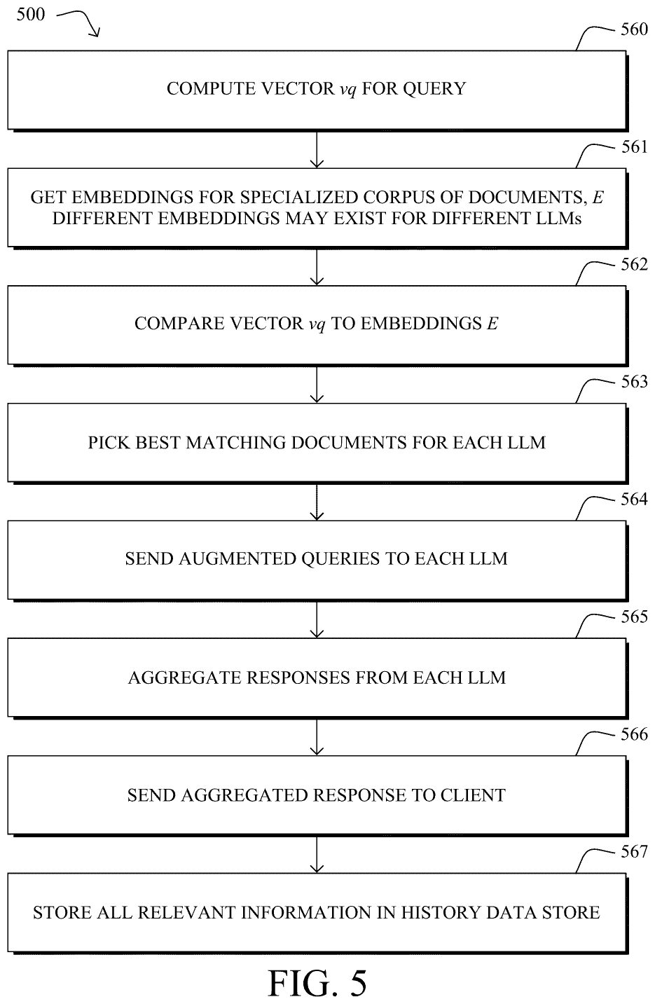

FIG. 5 illustrates an example flow for responding to a query using information from a specialized corpus of documents in accordance with the present disclosure; and

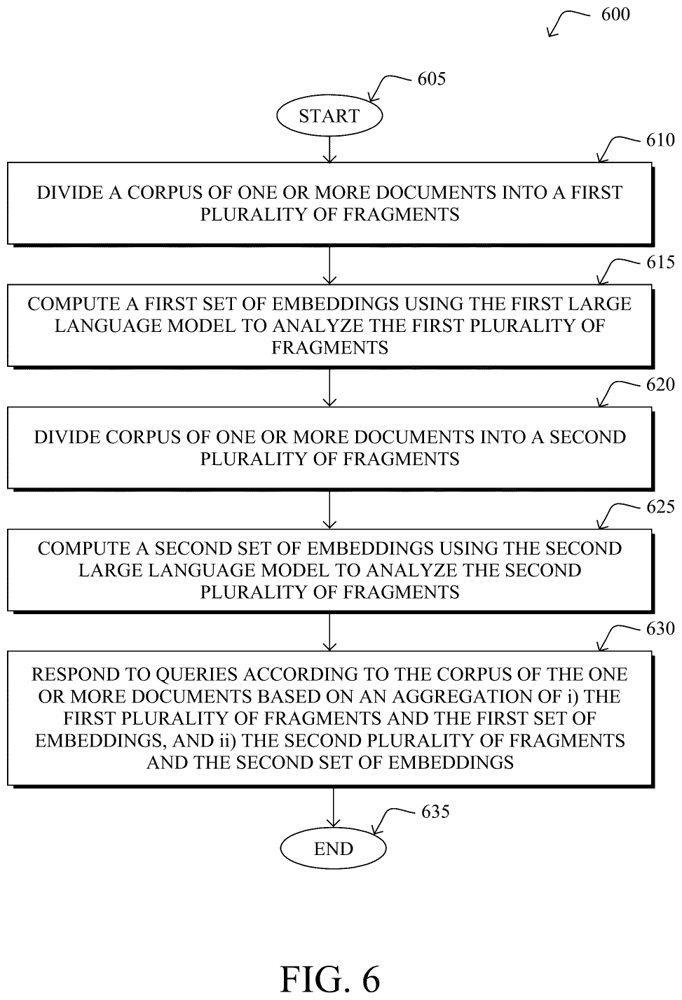

FIG. 6 illustrates an example procedure for managing embeddings and text for enhanced natural language understanding in accordance with the present disclosure.

### DESCRIPTION OF EXAMPLE EMBODIMENTS

### Overview

According to one or more embodiments of the disclosure, a method for managing embeddings and text for enhanced natural language understanding includes dividing, by a process, a corpus of one or more documents into a first plurality of fragments based on a first threshold size for a first large language model and computing, by the process, a first set of embeddings using the first large language model to analyze the first plurality of fragments. The method further includes dividing, by the process, the corpus of one or more documents into a second plurality of fragments based on a second threshold size for a second large language model and computing, by the process, a second set of embeddings using the second large language model to analyze the second plurality of fragments. In some implementations, responses to queries according to the corpus of the one or more documents are based on an aggregation of i) the first plurality of fragments and the first set of embeddings, and ii) the second plurality of fragments and the second set of embeddings.

Other implementations are described below, and this overview is not meant to limit the scope of the present disclosure.

### DESCRIPTION

A computer network is a geographically distributed collection of nodes interconnected by communication links and segments for transporting data between end nodes, such as personal computers and workstations, or other devices, such as sensors, etc. Many types of networks are available, ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), synchronous digital hierarchy (SDH) links, and others. The Internet is an example of a WAN that connects disparate networks throughout the world, providing global communication between nodes on various networks. Other types of networks, such as field area networks (FANs), neighborhood area networks (NANs), personal area networks (PANs), enterprise networks, etc. may also make up the components of any given computer network. In addition, a Mobile Ad-Hoc Network (MANET) is a kind of wireless ad-hoc network, which is generally considered a self-configuring network of mobile routers (and associated hosts) connected by wireless links, the union of which forms an arbitrary topology.

FIG. 1 is a schematic block diagram of an example simplified computing system (e.g., computing system 100) illustratively comprising any number of client devices (e.g., client devices 102, such as a first through nth client device), one or more servers (e.g., servers 104), and one or more databases (e.g., databases 106), where the devices may be in communication with one another via any number of networks (e.g., network(s) 110). The one or more networks (e.g., network(s) 110) may include, as would be appreciated, any number of specialized networking devices such as routers, switches, access points, etc., interconnected via wired and/or wireless connections. For example, the devices shown and/or the intermediary devices in network(s) 110 may communicate wirelessly via links based on WiFi, cellular, infrared, radio, near-field communication, satellite, or the like. Other such connections may use hardwired links, e.g., Ethernet, fiber optic, etc. The nodes/devices typically communicate over the network by exchanging discrete frames or packets of data (packets 140) according to predefined protocols, such as the Transmission Control Protocol/Internet Protocol (TCP/IP) other suitable data structures, protocols, and/or signals. In this context, a protocol consists of a set of rules defining how the nodes interact with each other.

Network(s) 110 may include, for example, network backbones or other internetworking systems, and may include various customer edge (CE) routers interconnected with provider edge (PE) routers in order to communicate across a core network to provide connectivity between devices which may be located in different geographical areas and/or on different types of local networks (e.g., local/branch networks versus data center/cloud environments). For example, these routers may be interconnected by the public Internet, a multiprotocol label switching (MPLS) virtual private network (VPN), or the like. In some implementations, a router or a set of routers may be connected to a private network (e.g., dedicated leased lines, an optical network, etc.) or a VPN (e.g., MPLS VPN) thanks to a carrier network, via one or more links exhibiting different network and service level agreement characteristics.

Client devices 102 may include any number of user devices or end point devices configured to interface with the techniques herein. For example, client devices 102 may include, but are not limited to, desktop computers, laptop computers, tablet devices, smart phones, wearable devices (e.g., heads up devices, smart watches, etc.), set-top devices, smart televisions, Internet of Things (IoT) devices, autonomous devices, or any other form of computing device capable of participating with other devices via network(s) 110.

Notably, in some implementations, servers 104 and/or databases 106, including any number of other suitable devices (e.g., firewalls, gateways, and so on) may be part of a cloud-based service. In such cases, the servers and/or databases 106 may represent the cloud-based device(s) that provide certain services described herein, and may be distributed, localized (e.g., on the premise of an enterprise, or “on prem”), or any combination of suitable configurations, as will be understood in the art. Servers 104, for example, may be configured as a network controller/supervisory service located in a data center with databases 106, accordingly. For instance, servers 104 may include, in various implementations, a network management server (NMS), a dynamic host configuration protocol (DHCP) server, a constrained application protocol (CoAP) server, an outage management system (OMS), an application policy infrastructure controller (APIC), an application server, etc.

Those skilled in the art will also understand that any number of nodes, devices, links, etc. may be used in computing system 100, and that the view shown herein is for simplicity. As would also be appreciated, computing system 100 may include any number of local networks, data centers, cloud environments, devices/nodes, servers, etc. Also, those skilled in the art will further understand that while the network is shown in a certain orientation, the computing system 100 is merely an example illustration that is not meant to limit the disclosure.

For instance, smart object networks, such as sensor networks, in particular, are a specific type of network (e.g., computing system 100) having spatially distributed autonomous devices such as sensors, actuators, etc., that cooperatively monitor physical or environmental conditions at different locations, such as, e.g., energy/power consumption, resource consumption (e.g., water/gas/etc. for advanced metering infrastructure or “AMI” applications) temperature, pressure, vibration, sound, radiation, motion, pollutants, etc. Other types of smart objects include actuators, e.g., responsible for turning on/off an engine or perform any other actions. Sensor networks, a type of smart object network, are typically shared-media networks, such as wireless or PLC networks. That is, in addition to one or more sensors, each sensor device (node) in a sensor network may generally be equipped with a radio transceiver or other communication port such as PLC, a microcontroller, and an energy source, such as a battery. Generally, size and cost constraints on smart object nodes (e.g., sensors) result in corresponding constraints on resources such as energy, memory, computational speed and bandwidth.

In some implementations, the techniques herein may be applied to still other network topologies and configurations. For example, the techniques herein may be applied to peering points with high-speed links, data centers, etc.

Notably, web services can be used to provide communications between electronic and/or computing devices over a network, such as the Internet. A web site is an example of a type of web service. A web site is typically a set of related web pages that can be served from a web domain. A web site can be hosted on a web server. A publicly accessible web site can generally be accessed via a network, such as the Internet. The publicly accessible collection of web sites is generally referred to as the World Wide Web (WWW).

Also, cloud computing generally refers to the use of computing resources (e.g., hardware and software) that are delivered as a service over a network (e.g., typically, the Internet). Cloud computing includes using remote services to provide a user's data, software, and computation.

Moreover, distributed applications can generally be delivered using cloud computing techniques. For example, distributed applications can be provided using a cloud computing model, in which users are provided access to application software and databases over a network. The cloud providers generally manage the infrastructure and platforms (e.g., servers/appliances) on which the applications are executed. Various types of distributed applications can be provided as a cloud service or as a Software as a Service (SaaS) over a network, such as the Internet.

According to various implementations, a software-defined WAN (SD-WAN) may be used in computing system 100 to connect local networks and data center/cloud environments. In general, an SD-WAN uses a software defined networking (SDN)-based approach to instantiate tunnels on top of the physical network and control routing decisions, accordingly. For example, one tunnel may connect a customer edge (CE) router at the edge of a local network to router a remote CE router at the edge of a data center/cloud environment over an MPLS or Internet-based service provider network in a network backbone. Similarly, a second tunnel may also connect these routers over a 4G/5G/LTE cellular service provider network. SD-WAN techniques allow the WAN functions to be virtualized, essentially forming a virtual connection between local networks and data center/cloud environments on top of the various underlying connections. Another feature of SD-WAN is centralized management by a supervisory service that can monitor and adjust the various connections, as needed.

FIG. 2 is a schematic block diagram of an example node/device 200 (e.g., an apparatus) that may be used with one or more implementations described herein, e.g., as any of the nodes or devices shown in FIG. 1 above or described in further detail below. The device 200 may comprise one or more of the network interfaces 210 (e.g., wired, wireless, etc.), input/output interfaces (I/O interfaces 215, inclusive of any associated peripheral devices such as displays, keyboards, cameras, microphones, speakers, etc.), at least one processor (e.g., processor(s) 220), and a memory 240 interconnected by a system bus 250, as well as a power supply 260 (e.g., battery, plug-in, etc.).

The network interfaces 210 include the mechanical, electrical, and signaling circuitry for communicating data over physical links coupled to the computing system 100. The network interfaces may be configured to transmit and/or receive data using a variety of different communication protocols. Notably, a physical network interface (e.g., network interfaces 210) may also be used to implement one or more virtual network interfaces, such as for virtual private network (VPN) access, known to those skilled in the art.

The memory 240 comprises a plurality of storage locations that are addressable by the processor(s) 220 and the network interfaces 210 for storing software programs and data structures associated with the implementations described herein. The processor(s) 220 may comprise necessary elements or logic adapted to execute the software programs and manipulate the data structures 245. An operating system 242 (e.g., the Internetworking Operating System, or IOS®, of Cisco Systems, Inc., another operating system, etc.), portions of which are typically resident in memory 240 and executed by the processor(s), functionally organizes the node by, inter alia, invoking network operations in support of software processors and/or services executing on the device. These software processors and/or services may comprise one or more functional processes 246, and on certain devices, an embedding management process (process 248), as described herein, each of which may alternatively be located within individual network interfaces.

Notably, one or more functional processes 246, when executed by processor(s) 220, cause each device 200 to perform the various functions corresponding to the particular device's purpose and general configuration. For example, a router would be configured to operate as a router, a server would be configured to operate as a server, an access point (or gateway) would be configured to operate as an access point (or gateway), a client device would be configured to operate as a client device, and so on.

It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while the processes have been shown separately, those skilled in the art will appreciate that processes may be routines or modules within other processes.

In various implementations, as detailed further below, one or more functional processes 246 and/or embedding management process (process 248) may include computer executable instructions that, when executed by processor(s) 220, cause device 200 to perform the techniques described herein. To do so, in some implementations, one or more functional processes 246 and/or process 248 may utilize machine learning. In general, machine learning is concerned with the design and the development of techniques that take as input empirical data (such as network statistics and performance indicators) and recognize complex patterns in these data. One very common pattern among machine learning techniques is the use of an underlying model M, whose parameters are optimized for minimizing the cost function associated to M, given the input data. For instance, in the context of classification, the model M may be a straight line that separates the data into two classes (e.g., labels) such that M=a*x+b*y+c and the cost function would be the number of misclassified points. The learning process then operates by adjusting the parameters a, b, c such that the number of misclassified points is minimal. After this optimization phase (or learning phase), model M can be used very easily to classify new data points. Often, M is a statistical model, and the cost function is inversely proportional to the likelihood of M, given the input data.

In various implementations, one or more functional processes 246 and/or process 248 may employ one or more supervised, unsupervised, or semi-supervised machine learning models. Generally, supervised learning entails the use of a training set of data, as noted above, that is used to train the model to apply labels to the input data. For example, the training data may include sample network observations that do, or do not, violate a given network health status rule and are labeled as such. On the other end of the spectrum are unsupervised techniques that do not require a training set of labels. Notably, while a supervised learning model may look for previously seen patterns that have been labeled as such, an unsupervised model may instead look to whether there are sudden changes in the behavior. Semi-supervised learning models take a middle ground approach that uses a greatly reduced set of labeled training data.

Example machine learning techniques that one or more functional processes 246 and/or process 248 can employ may include, but are not limited to, nearest neighbor (NN) techniques (e.g., k-NN models, replicator NN models, etc.), statistical techniques (e.g., Bayesian networks, etc.), clustering techniques (e.g., k-means, mean-shift, etc.), neural networks (e.g., reservoir networks, artificial neural networks, etc.), support vector machines (SVMs), generative adversarial networks (GANs), long short-term memory (LSTM), logistic or other regression, Markov models or chains, principal component analysis (PCA) (e.g., for linear models), singular value decomposition (SVD), multi-layer perceptron (MLP) artificial neural networks (ANNs) (e.g., for non-linear models), replicating reservoir networks (e.g., for non-linear models, typically for timeseries), random forest classification, or the like.

In further implementations, one or more functional processes 246 and/or process 248 may also include one or more generative artificial intelligence/machine learning models. In contrast to discriminative models that simply seek to perform pattern matching for purposes such as anomaly detection, classification, or the like, generative approaches instead seek to generate new content or other data (e.g., audio, video/images, text, etc.), based on an existing body of training data. For instance, in the context of network assurance, one or more functional processes 246 and/or process 248 may use a generative model to generate synthetic network traffic based on existing user traffic to test how the network reacts. Example generative approaches can include, but are not limited to, generative adversarial networks (GANs), large language models (LLMs), other transformer models, and the like. In some instances, one or more functional processes 246 and/or process 248 may be executed to intelligently route LLM workloads across executing nodes (e.g., communicatively connected GPUs clustered into domains).

The performance of a machine learning model can be evaluated in a number of ways based on the number of true positives, false positives, true negatives, and/or false negatives of the model. For example, the false positives of the model may refer to the number of times the model incorrectly predicted whether a network health status rule was violated. Conversely, the false negatives of the model may refer to the number of times the model predicted that a health status rule was not violated when, in fact, the rule was violated. True negatives and positives may refer to the number of times the model correctly predicted whether a rule was violated or not violated, respectively. Related to these measurements are the concepts of recall and precision. Generally, recall refers to the ratio of true positives to the sum of true positives and false negatives, which quantifies the sensitivity of the model. Similarly, precision refers to the ratio of true positives to the sum of true and false positives.

### ——Managing Embeddings and Text for Enhanced Natural Language Understanding——

As noted above, recent breakthroughs in large language models (LLMs), such as ChatGPT and GPT-4, represent new opportunities across a wide spectrum of industries. The ability of these models to follow instructions now allow for interactions with tools (also called plugins) that are able to perform tasks such as searching the web, executing code, etc. In addition, LLMs are also able to interact with human users in a conversational manner to provide answers to highly technical and complex questions.

To enhance the performance of an LLM-based system, techniques such as retrieval augmented generation (RAG) have arisen whereby different documents are used to enhance the input prompt from the user, to add additional context to it. Typically, this is done by converting both the documents and the prompt into embeddings, then performing a match to add the most relevant context to the prompt for input to the LLM.

Currently, though, documents are converted into single sets of embeddings. This means that the amount of context available for addition to the prompt is at a fixed degree of granularity. In addition, the match between the document embeddings and that of the prompt is made based on their vector similarities according to a fixed metric. Thus, current LLM systems are relatively inflexible and do not allow for any actual control over their RAG mechanisms.

The techniques herein allow for the flexible management of embeddings in an LLM system, allowing for multiple sets of embeddings to be stored for a given document at different granularities. In addition, the techniques herein also allow for control over the metrics that the system uses to determine vector similarity matches when performing retrieval augmented generation (RAG).

Specifically, according to one or more embodiments of the disclosure as described in detail below, a method for managing embeddings and text for enhanced natural language understanding includes dividing, by a process, a corpus of one or more documents into a first plurality of fragments based on a first threshold size for a first large language model and computing, by the process, a first set of embeddings using the first large language model to analyze the first plurality of fragments. The method further includes dividing, by the process, the corpus of one or more documents into a second plurality of fragments based on a second threshold size for a second large language model and computing, by the process, a second set of embeddings using the second large language model to analyze the second plurality of fragments. In some implementations, responses to queries according to the corpus of the one or more documents are based on an aggregation of i) the first plurality of fragments and the first set of embeddings, and ii) the second plurality of fragments and the second set of embeddings

As discussed in more detail below, the techniques described herein are particularly relevant for developing customized natural language understanding services. For example, specialized natural language processing (NLP) systems are disclosed herein which can be customized to specific language domains. Examples of scenarios in which NLPs can be customized to specific language domains can include computer security, finance and economics, and/or legal documents, among others. Another issue addressed by the techniques herein is that information from LLMs can be outdated. For example, LLMs such as ChatGPT may not have recent data, where specialized NLP systems can provide more updated data.

In general, the techniques described herein can allow for a specialized corpus of text documents to be created. This can typically require data extraction and cleaning of documents. These documents can then be converted to vectors. In some implementations, several different models can be used to convert documents to vectors. Semantic similarity of documents can be determined by comparing their vectors and multiple algorithms can be used for comparing these vectors.

As mentioned above, aspects of the present disclosure are directed to methods and systems (e.g., the system 300) for managing vector embeddings for applications such as natural language understanding systems. Existing methods are insufficient for applications requiring multiple types of embeddings for the same data set due to the inflexibility of such approaches, as discussed above.

A key motivating example for the use of the techniques described herein is the development of customized natural language understanding systems built on top of large language models (LLMs) such as ChatGPT, Bard, and Llama 2. These customized natural language understanding systems allow users to ask questions about and analyze customized documents of their own choosing. For example, customized natural language understanding systems can be developed in a specific area such as computer security. Such customized natural language understanding systems allow users to issue queries which the LLM by itself cannot answer.

In order to build such customized natural language understanding systems, it is necessary to obtain appropriate documents containing the relevant background information and to analyze the documents. In some implementations, if the background information is confidential, it is possible to use a private LLM which cannot be accessed by companies such as OpenAI and Google.

In some implementations, vector embeddings are utilized. Vector embeddings, often referred to simply as “embeddings,” are a fundamental concept in natural language processing (NLP) and machine learning. Embeddings are a way to represent objects, such as words, phrases, sentences, or even entire documents, as vectors (arrays of numbers) in a high-dimensional space. These vectors are designed in such a way that they capture meaningful relationships and similarities between the objects they represent.

At the outset, it may be beneficial to highlight some key points regarding vector embeddings:
Representation of Objects: Embeddings are used to represent objects in a numerical format. In NLP, these objects are typically words or tokens, but embeddings can be used in various domains beyond NLP.
Semantic Meaning: Good embeddings are designed to capture semantic meaning. Words or objects that are semantically similar should have similar vector representations. For example, in a good word embedding model, the vectors for “king” and “queen” should be closer to each other in the vector space than to unrelated words like “cat” or “dog.”
High-Dimensional Space: The vectors are often represented in a high-dimensional space, with each dimension of the space corresponding to some aspect of meaning or context. Common dimensions may represent things like word frequency, syntactic relationships, or semantic concepts.
Learned from Data: Embeddings are typically learned from data using machine learning techniques. For example, word embeddings like Word2Vec, GloVe, or FastText are trained on large text corpora to learn vector representations for words. These models learn to predict word contexts based on co-occurrence statistics.
Transferable: Pre-trained embeddings can be transferred to various NLP tasks. For instance, a word embedding model trained on a large corpus can be used as a feature representation for a wide range of NLP tasks, such as text classification, sentiment analysis, or machine translation. This is known as transfer learning or fine-tuning.
Word Embeddings vs. Document Embeddings: While word embeddings represent individual words as vectors, document embeddings represent entire documents, such as sentences or paragraphs, as vectors. Document embeddings aim to capture the overall meaning or topic of the document.
Visualization: Although embeddings exist in high-dimensional spaces, they can be visualized in lower dimensions (e.g., 2D or 3D) for better human understanding. Techniques like Principal Component Analysis (PCA) or t-SNE (t-Distributed Stochastic Neighbor Embedding) are often used for this purpose.

Vector embeddings are a powerful tool in machine learning and NLP because they provide a way to work with textual data in a format that algorithms can understand and leverage for various tasks. They have played a crucial role in advancing the state-of-the-art in NLP and related fields.

A number of tools have been developed for storing vectors. In addition to traditional databases and file systems, vector databases such as Pinecone, Weiviate, and Chroma exist for storing and manipulating vectors.

Vector databases are only part of the solution, however. There are often situations in which it is necessary to handle multiple ways of performing embeddings for the same data set. In these situations, it is necessary to have additional infrastructure for managing embeddings.

As a specific example, consider a set of natural language documents. The natural language documents might correspond to a specific subject domain such as computer security or economics and finance. The natural language documents need to be embedded into vectors. A large document is typically broken into multiple fragments, where each fragment corresponds to a single vector. Fragments can be selected based on size. Generally, it is desired to avoid having a single fragment that is too large or too small.

Breaking up a document into fragments purely based on size is often not going to be sufficient. Semantic meaning should also be considered. It makes sense to define fragments which correspond to logical sections of a document. For example, a section of a document could correspond to one fragment. The next section of the document, when corresponding to a different subject, could be a different fragment.

Syntax should also be considered. For example, it is probably not a good idea to end a fragment in the middle of a sentence. It may also be a bad idea to end a fragment in the middle of a paragraph. Accordingly, the size, semantics, and syntax should be considered in creating fragments.

Another key point is that different embeddings may be appropriate for the same fragments. For example, different models can be used for embeddings. It may be desirable to create different embeddings for the same fragments using different models (or the same models using different parameter settings).

Semantic information can also be considered in computing fragments. Fragments typically correspond to text having a common subject matter. When the subject matter changes, it can be advisable to generate a new fragment for the new subject matter.

In some cases, the syntax of documents can be used in determining fragments. For example, different sections of the document could be placed in different fragments. A change in section could indicate a change in subject matter.

In other cases, paragraph structure can be used to determine fragments. It may be undesirable to break up a paragraph so that the paragraph is spread across multiple fragments.

Operationally, FIG. 3 illustrates an example system 300 for managing embeddings and text for enhanced natural language understanding in accordance with the disclosure. As shown in FIG. 3, an external network 340 may be communicatively coupled to a plurality of components/modules. The components/modules can be provisioned with hardware resources that operate to execute instructions (e.g., computer code or other such instructions) to perform the operations described herein.

In some implementations, the external network 340 may be coupled to the network interface 210 and/or the I/O interface 215 of FIG. 2. On one “side” (e.g., a cloud or serve side) of the external network 340, the external network may be in communication with one or more LLMs, such as a first LLM (e.g., LLM1 342), a second LLM (e.g., LLM2 344), and/or a third LLM (e.g., LLM3 346). Non-limiting examples of these LLMs can include contemporary LLMs, such as ChatGPT, Bard, and/or Llama2, among others. It is noted that these example LLMs are mentioned merely for illustration purposes and as will be appreciated, the external network 340 may be in communication with other LLMs. In addition, the external network 340 can be configured to communicate to one or more external websites 348 via, for example, the document extractor 334 discussed below.

On another “side” (e.g., a user device side) of the external network 340, a user device may include a user interface 320, which can be used to access a query handler 322. The query handler can be configured to exchange information with a history data store 328, an LLM proxy 330 (which can include a cache 332), and an embeddings manager 324. The embeddings manager 324 can be configured to access information from an embeddings store 326, a document fragment store 336, and/or a document store 338. In some implementations, the document store 338 can be configured to access information from a document extractor 334. Finally, as mentioned above, the document extractor 334 may be in communication with one or more external websites 348.

In some implementations, the user interface 320 can be a graphical user interface that is provided to a user in order to input various commands (e.g., queries, such as prompts to be input into an LLM) to a computing device. The query handler 322 can be configured to execute one or more methodologies and/or searches based on text inputs received from the user interface 320 in order to communicate with inputs received via the user interface 320. In some implementations, the history data store 328 can be configured to store information related to various queries and/or can assist in the deployment of RAG techniques in an effort to mitigate LLM hallucinations and/or out-of-date training data.

The LLM proxy 330 can be configured to provide support to upstream LLM providers, such as the as LLM1 342, LLM2 344, and/or LLM3 346 illustrated in FIG. 3, among others. In addition, the LLM proxy 330 can provide tuning to the LLMs without necessarily changing the weights of the models used in conjunction with the LLMs. The cache 332 can, as will be appreciated, provide a temporary storage area that can be utilized by the LLM proxy 330 during performance of operations carried out by the LLM proxy 330.

In some implementations, the embeddings manager 324 can be configured to process and/or manage embeddings associated with the embeddings store 326, the document fragment store 336, and/or the document store 338. As will be appreciated, the term “embeddings” generally refers to a representation of high-dimensional data in a low-dimensional space. In general, embeddings enable deep-learning models (e.g., LLMs) to understand real-world data domains more effectively by simplifying how real-world data is represented while retaining the semantic and syntactic relationships. This can allow machine learning algorithms, such as LLMs, to extract and process complex data types.

High-dimensional data may refer to datasets with many features or attributes that define each data point. This can mean tens, hundreds, or even thousands of dimensions may need to be considered to perform machine learning algorithms. In general, when presented with high-dimensional data, deep-learning models require more computational power and time to learn, analyze, and infer accurately. Fortunately, embeddings may reduce the number of dimensions by identifying commonalities and patterns between various features to produce representations of high-dimensional data in a low-dimensional space, which can reduce the computing resources and time required to process raw data.

Implementations discussed herein leverage the embeddings manager 324 to process and/or manage embeddings associated with the embeddings store 326, the document fragment store 336, and/or the document store 338 to convert high-dimensional data to a low-dimensional space, thereby reducing the computing resources and time required to process data (e.g., queries received via the user interface 320) and allow for the flexible management of embeddings in an LLM system while processing multiple sets of embeddings to be stored for a given document at different granularities.

As will be appreciated, the embeddings store 326, the document fragment store 336, and/or the document store 338 can be repositories for persistently storing and/or managing collections of data which can include databases, files, words, phrases, sentences, and/or documents, some, or all of which may be represented as vectors. The document extractor 334 can retrieve information (e.g., data) from the embeddings store 326, the document fragment store 336, and/or the document store 338 for further data processing or data storage and/or for purposes of data migration. In addition, the document extractor 334 can retrieve information that is unstructured (e.g., data from web pages, emails, documents, PDFs, social media, scanned text, mainframe reports, spool files, multimedia files, etc.) and process such data to provide the same to the embeddings store 326, the document fragment store 336, and/or the document store 338.

FIG. 4 illustrates an example flow 400 for managing documents and embeddings in accordance with the present disclosure. At operation 450, one or more documents may be broken into fragments. A key reason for doing so is because LLMs generally have a maximum token limit. For example, as of Jun. 18, 2024, OpenAI's gpt-4-turbo-2024-04-09 model has a token limit of 128,000 tokens where the tokens are approximately four characters. Further, ChatGPT token limits may include the token count from both the message list sent and the model response. Other example token limits for other LLMs can be: gpt-4-0613 with a token limit of 8,192 tokens, gpt-3.5-turbo-instructwith a token limit of 4,096 tokens, gpt-3.5-turbo-0125 with a token limit of 16,385 tokens, Bard, which in the past has had a character limit of around 4,000 characters (e.g., approximately 1,000 tokens) with a maximum output size of around 10,000 characters or approximately 2,500 tokens, etc. Given the above, very large documents may not be able to be processed by an LLM. Accordingly, the documents may be broken into smaller fragments as shown at operation 450.

In some implementations, it can be advantageous to perform multiple embeddings for the same corpus of text information at different levels of granularity. For example, the optimal length of text corresponding to a single vector may depend on maximum input length of LLM. Accordingly, a longer maximum input length means that a single vector can encompass more text. A vector, in general, can correspond to text with a length of about 10% of the total size allowed for background material and can provide around 10 documents to the LLM as background context for the query without exceeding an example token limit. For example, suppose that embeddings are being calculated to determine text for augmenting queries to a large language model. If the queries are intended to be sent to, for example, gpt-4-turbo-2024-04-09, then it may be possible to map longer blocks of text to individual vectors than Bard due to the considerably longer input size that gpt-4-turbo-2024-04-09 accepts, etc.

At operation 452, embeddings are computed for the fragments. A variety of different models can be used for computing the embeddings. Next, at operation 454, the fragments and embeddings are stored persistently. There are several methods by which the embeddings can be stored. These can include file systems, relational database management systems, NoSQL stores, as well as various cloud-based storage systems. Implementations are not so limited, however, and the embeddings and/or vectors may also be stored in a vector database such as Pinecone, Weiviate, or Chroma, although it will be appreciated that these databases may not adequately handle multiple embeddings for same document set, may cost money to use, and/or may incur higher latencies on retrieval than persistent storage methodologies.

FIG. 5 illustrates an example flow 500 for responding to a query using information from a specialized corpus of documents in accordance with the present disclosure. Initially, a query is made to a system (e.g., the system 300 of FIG. 3) that includes an LLM. An example of such a query may be “what is a pretending jailbreak attack on LLMs,” although it will be appreciated that this query is merely illustrative and any type of query can be made to the system. At operation 560, a vector “vq” is computed for the query. As will be appreciated, a variety of different models can be used for creating the vector, vq. The vector, vq, can be sent to one or more LLMs. In the illustrative example of FIG. 5, the vector vq is sent to multiple LLMs. The system can then store multiple sets of embeddings corresponding to the vector vq. These embeddings can be optimized for different ways of fragmenting documents, as discussed above.

At operation 561, the system determines the right embeddings for each LLM. These embeddings, “E,” are determined based on the token size limits for the LLMs. As mentioned above, the correct set of embeddings can depend on the token limit for the LLM. In some implementations, the different embeddings are optimized for different token limits, thereby allowing for the system to select the correct set of embeddings based on the token size limits for the LLMs.

At operation 562, the vector, vq is compared to each set of embeddings in E. In accordance with the disclosure, each LLM should have a set of embeddings corresponding thereto. In some cases, the same set of embeddings can be used for different LLMs. For example, if the LLMs have similar token size limits, the same set of embeddings may be assigned to such LLMs; however, for LLMs having different token size limits, different sets of embeddings per LLM may be utilized.

In accordance with the disclosure, multiple methods can be used to compare vq to E. For example, cosine similarity, dot product, Euclidean distance, Manhattan distance, and/or Minkowski distance (which is a generalization of Euclidean and Manhattan distance), among others may be used to compare vq to E. A straightforward example comparison method may have a computational overhead of O(n), where n is the number of vectors in E. However, more efficient algorithms can reduce computational overhead. In addition, it is noted that libraries such as Faiss may use approximations which can reduce computation time. Further, vector databases which are well designed can also reduce computation time in some implementations.

At operation 563, document fragments with vectors having high similarity may be selected to augment queries for each LLM. As discussed above, the similarity between the document fragments and the vectors can be computed using a variety of methodologies.

At operation 564, augmented queries are sent to each LLM. The augmented queries can contain information corresponding to the document fragments with vectors having a high degree of similarity, as discussed above.

At operation 565, responses are obtained from each LLM and aggregated. For example, each of the LLMs can respond to the initial query, and these responses can be aggregated to enhance a response that would normally be generated in other approaches. Accordingly, in some implementations, an aggregated response from multiple LLMs that is also based on the augmented queries that are posed to each of the LLMs can be generated in accordance with the disclosure.

At operation 566, the aggregated responses can be returned to the client (e.g., the user who posed the initial query).

At operation 567, historical information, including the query and/or aggregated responses, can be stored by the system. In some implementations, this historical information can be stored in a persistent manner such that the historical information can be analyzed at a later time.

In closing, FIG. 6 illustrates an example procedure for managing embeddings and text for enhanced natural language understanding in accordance with the present disclosure, particularly from the perspective of a system or device. For example, a non-generic, specifically configured device (e.g., device 200, an apparatus) may perform procedure 600 by executing stored instructions (e.g., process 248). The procedure 600 may start at step 605, and continues to step 610, where, as described in greater detail above, a process divides a corpus of one or more documents into a first plurality of fragments based on a first threshold size for a first large language model. In some implementations, dividing the corpus of the one or more documents into the first plurality of fragments can be based further on semantic content associated with the corpus of the one or more documents. For example, in some implementations, the corpus of the one or more documents can be divided into the first plurality of fragments based further on a syntax associated with the corpus of the one or more documents.

The procedure 600 may continue to step 615 where, as described in greater detail above, the process computes a first set of embeddings using the first large language model to analyze the first plurality of fragments.

The procedure 600 may continue to step 620 where, as described in greater detail above, the process divides the corpus of one or more documents into a second plurality of fragments based on a second threshold size for a second large language model. In some implementations, dividing the corpus of the one or more documents into the second plurality of fragments can be based further on the semantic content associated with the corpus of the one or more documents. For example, in some implementations, the corpus of the one or more documents can be divided into the second plurality of fragments based further on the syntax associated with the corpus of the one or more documents.

The procedure 600 may continue to step 625 where, as described in greater detail above, the process computes a second set of embeddings using the second large language model to analyze the second plurality of fragments.

In some implementations, as shown in optional step 630 (which may be performed by a same device/process or a different device/process), responses to queries according to the corpus of the one or more documents are based on an aggregation of i) the first plurality of fragments and the first set of embeddings, and ii) the second plurality of fragments and the second set of embeddings. In some implementations, the responses to queries based on the corpus of one or more documents aggregate results from i) the first large language model using the first plurality of fragments and the first set of embeddings, and ii) the second large language model using the second plurality of fragments and the second set of embeddings. In still other implementations, the aggregation for the responses to queries can be performed by a third large language model.

In some implementations, the process can compute additional pluralities of fragments and additional sets of embeddings for additional large language models based on additional threshold sizes for the additional large language models.

As discussed above, the first plurality of fragments, the first set of embeddings, the second plurality of fragments, and the second set of embeddings can be stored in a persistent storage. This can allow for subsequent retrieval of the first plurality of fragments, the first set of embeddings, the second plurality of fragments, and the second set of embeddings for future use and/or analysis. For example, in some implementations, the procedure 600 can include retrieving the first plurality of fragments, the first set of embeddings, the second plurality of fragments, and the second set of embeddings from the persistent storage for later use by the first large language model or the second large language model.

In some implementations, one or more of the first plurality of fragments can be stored in a file system, a relational database management system, or a NoSQL database and one or more of the second plurality of fragments can be stored in the file system, the relational database management system, or the NoSQL database. In other implementations, one or more of the first set of embeddings can be stored in a vector database, a file system, a relational database management system, or a NoSQL database and one or more of the second set of embeddings can be stored in the vector database, the file system, the relational database management system, or the NoSQL database.

In some implementations, the procedure 600 can include comparing a vector associated with the queries to the first plurality of fragments and to the second plurality of fragments to determine vector similarity matches as part of providing responses to the queries. This can allow for control over the metrics that the system uses to determine vector similarity matches when performing retrieval augmented generation (RAG).

Procedure 600 may end at step 635.

In some implementations, a non-generic, specifically configured device (e.g., device 200, an apparatus) may perform a procedure in accordance with the disclosure by executing stored instructions (e.g., process 248). This procedure can include determining a first threshold size for a first large language model based on a maximum size that the first large language model can accommodate and determining a second threshold size for a second large language model based on a maximum size that the second large language model can accommodate. The procedure can further include dividing a plurality of documents into a first plurality of fragments based on semantic content of the plurality of documents and the first threshold size and dividing the plurality of documents into a second plurality of fragments based on semantic content of the plurality of documents and the second threshold size. The procedure can then include computing a first set of embeddings using the first large language model to analyze the first plurality of fragments and computing a second set of embeddings using the second large language model to analyze the second plurality of fragments. Finally, this procedure can include storing the first plurality of fragments, the first set of embeddings, the second plurality of fragments, and the second set of embeddings in a persistent storage.

This procedure can also include computing additional pluralities of fragments and additional sets of embeddings for additional large language models based on maximum sizes that the additional large language models can accommodate. Further, in some implementations, at least some of the first plurality of fragments or the second plurality of fragments are stored in one of a file system, a relational database management system, or a NoSQL database and/or at least some of the first set of embeddings or the second set of embeddings are stored in one of a vector database, a file system, a relational database management system, or a NoSQL database. In still other implementations, at least one of the maximum size that the first large language model can accommodate and the maximum size that the second large language model can accommodate can comprise a token limit.

It should be noted that while certain steps within the procedures above may be optional as described above, the steps shown in the procedures above are merely examples for illustration, and certain other steps may be included or excluded as desired. Further, while a particular order of the steps is shown, this ordering is merely illustrative, and any suitable arrangement of the steps may be utilized without departing from the scope of the embodiments herein. Moreover, while procedures may have been described separately, certain steps from each procedure may be incorporated into each other procedure, and the procedures are not meant to be mutually exclusive.

In some implementations, an illustrative apparatus herein may comprise: one or more network interfaces to communicate with a network; a processor coupled to the one or more network interfaces and configured to execute one or more processes; and a memory configured to store a process that is executable by the processor, the process comprising: dividing, by a process, a corpus of one or more documents into a first plurality of fragments based on a first threshold size for a first large language model; computing, by the process, a first set of embeddings using the first large language model to analyze the first plurality of fragments; dividing, by the process, the corpus of one or more documents into a second plurality of fragments based on a second threshold size for a second large language model; and computing, by the process, a second set of embeddings using the second large language model to analyze the second plurality of fragments. In some implementations, responses to queries according to the corpus of the one or more documents are based on an aggregation of i) the first plurality of fragments and the first set of embeddings, and ii) the second plurality of fragments and the second set of embeddings.

In still other implementations, a tangible, non-transitory, computer-readable medium storing program instructions that cause a device to execute a process comprising: dividing, by a process, a corpus of one or more documents into a first plurality of fragments based on a first threshold size for a first large language model; computing, by the process, a first set of embeddings using the first large language model to analyze the first plurality of fragments; dividing, by the process, the corpus of one or more documents into a second plurality of fragments based on a second threshold size for a second large language model; and computing, by the process, a second set of embeddings using the second large language model to analyze the second plurality of fragments. In some implementations, responses to queries according to the corpus of the one or more documents are based on an aggregation of i) the first plurality of fragments and the first set of embeddings, and ii) the second plurality of fragments and the second set of embeddings.

The techniques described herein, therefore, provide for managing documents and embeddings. More specifically, the techniques herein allow for the flexible management of embeddings in an LLM system, allowing for multiple sets of embeddings to be stored for a given document at different granularities. In addition, the techniques herein also allow for control over the metrics that the system uses to determine vector similarity matches when performing retrieval augmented generation (RAG).

Illustratively, the techniques described herein may be performed by hardware, software, and/or firmware, (e.g., an “apparatus”) such as in accordance with the embedding management process, process 248, e.g., a “method”), which may include computer-executable instructions executed by the processor(s) 220 to perform functions relating to the techniques described herein, e.g., in conjunction with corresponding processes of other devices in the computer network as described herein (e.g., on agents, controllers, computing devices, servers, etc.). In addition, the components herein may be implemented on a singular device or in a distributed manner, in which case the combination of executing devices can be viewed as their own singular “device” for purposes of executing the process (e.g., process 248).

While there have been shown and described illustrative implementations above, it is to be understood that various other adaptations and modifications may be made within the scope of the implementations herein. For example, while certain implementations are described herein with respect to certain types of networks in particular, the techniques are not limited as such and may be used with any computer network, generally, in other implementations. Moreover, while specific technologies, protocols, architectures, schemes, workloads, languages, etc., and associated devices have been shown, other suitable alternatives may be implemented in accordance with the techniques described above. In addition, while certain devices are shown, and with certain functionality being performed on certain devices, other suitable devices and process locations may be used, accordingly. Also, while certain embodiments are described herein with respect to using certain models for particular purposes, the models are not limited as such and may be used for other functions, in other embodiments.

Moreover, while the present disclosure contains many other specifics, these should not be construed as limitations on the scope of any implementation or of what may be claimed, but rather as descriptions of features that may be specific to particular implementations. Certain features that are described in this document in the context of separate implementations can also be implemented in combination in a single implementation. Conversely, various features that are described in the context of a single implementation can also be implemented in multiple implementations separately or in any suitable sub-combination. Further, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. Moreover, the separation of various system components in the implementations described in the present disclosure should not be understood as requiring such separation in all implementations.

The foregoing description has been directed to specific implementations. It will be apparent, however, that other variations and modifications may be made to the described implementations, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the implementations herein. Therefore, it is the object of the appended claims to cover all such variations and modifications as come within the true intent and scope of the implementations herein.

1. A method, comprising:
dividing, by a computing system comprising one or more processors configured to perform one or more processes, a corpus of one or more documents into a first plurality of fragments based on a first threshold size for a first large language model;
computing, by the computing system comprising one or more processors configured to perform one or more processes, a first set of embeddings using the first large language model to analyze the first plurality of fragments;
dividing, by the computing system comprising one or more processors configured to perform one or more processes, the corpus of one or more documents into a second plurality of fragments based on a second threshold size for a second large language model; and
computing, by the computing system comprising one or more processors configured to perform one or more processes, a second set of embeddings using the second large language model to analyze the second plurality of fragments; and
comparing a vector associated with queries to the first plurality of fragments and to the second plurality of fragments to determine vector similarity matches as part of providing responses to the queries,
wherein the responses to the queries according to the corpus of the one or more documents are based on an aggregation of i) the first plurality of fragments and the first set of embeddings, and ii) the second plurality of fragments and the second set of embeddings.

2. The method of claim 1, wherein the responses to queries based on the corpus of one or more documents aggregate results from i) the first large language model using the first plurality of fragments and the first set of embeddings, and ii) the second large language model using the second plurality of fragments and the second set of embeddings.

3. The method of claim 1, further comprising:
dividing the corpus of the one or more documents into the first plurality of fragments based further on semantic content associated with the corpus of the one or more documents; and
dividing the corpus of the one or more documents into the second plurality of fragments based further on the semantic content associated with the corpus of the one or more documents.

4. The method of claim 1, further comprising:
computing additional pluralities of fragments and additional sets of embeddings for additional large language models based on additional threshold sizes for the additional large language models.

5. The method of claim 1, further comprising:
storing the first plurality of fragments, the first set of embeddings, the second plurality of fragments, and the second set of embeddings in a persistent storage.

6. The method of claim 5, further comprising:
retrieving the first plurality of fragments, the first set of embeddings, the second plurality of fragments, and the second set of embeddings from the persistent storage for later use by the first large language model or the second large language model.

7. The method of claim 1, wherein the aggregation for the responses to queries is performed by a third large language model.

8. The method of claim 1, wherein:
one or more of the first plurality of fragments are stored in a file system, a relational database management system, or a NoSQL database, and
one or more of the second plurality of fragments are stored in the file system, the relational database management system, or the NoSQL database.

9. The method of claim 1, wherein:
one or more of the first set of embeddings are stored in a vector database, a file system, a relational database management system, or a NoSQL database, and one or more of the second set of embeddings are stored in the vector database, the file system, the relational database management system, or the NoSQL database.

10. The method of claim 1, further comprising:
dividing the corpus of the one or more documents into the first plurality of fragments based further on a syntax associated with the corpus of the one or more documents; and
dividing the corpus of the one or more documents into the second plurality of fragments based further on the syntax associated with the corpus of the one or more documents.

11. (canceled)

12. A method, comprising:
determining, by a computing system comprising one or more processors configured to perform one or more processes, a first threshold size for a first large language model based on a maximum size that the first large language model can accommodate;
determining, by the computing system comprising one or more processors configured to perform one or more processes, a second threshold size for a second large language model based on a maximum size that the second large language model can accommodate;
dividing a plurality of documents into a first plurality of fragments based on semantic content of the plurality of documents, a syntax associated with the plurality of documents, and the first threshold size;
dividing the plurality of documents into a second plurality of fragments based on the semantic content of the plurality of documents, the syntax associated with the plurality of documents, and the second threshold size;
computing, by the computing system comprising one or more processors configured to perform one or more processes, a first set of embeddings using the first large language model to analyze the first plurality of fragments;
computing, by the computing system comprising one or more processors configured to perform one or more processes, a second set of embeddings using the second large language model to analyze the second plurality of fragments; and
storing the first plurality of fragments, the first set of embeddings, the second plurality of fragments, and the second set of embeddings in a persistent storage.

13. The method of claim 12, further comprising:
computing additional pluralities of fragments and additional sets of embeddings for additional large language models based on maximum sizes that the additional large language models can accommodate.

14. The method of claim 12, wherein at least some of the first plurality of fragments or the second plurality of fragments are stored in one of a file system, a relational database management system, or a NoSQL database.

15. The method of claim 12, wherein at least some of the first set of embeddings or the second set of embeddings are stored in one of a vector database, a file system, a relational database management system, or a NoSQL database.

16. The method of claim 12, wherein at least one of the maximum size that the first large language model can accommodate and the maximum size that the second large language model can accommodate comprises a token limit.

17. An apparatus, comprising:
one or more network interfaces to communicate with a network;
a processor coupled to the one or more network interfaces and configured to execute one or more processes; and
a memory configured to store a process that is executable by the processor, the process comprising:
dividing, by a process, a corpus of one or more documents into a first plurality of fragments based on a first threshold size for a first large language model;
computing, by the process, a first set of embeddings using the first large language model to analyze the first plurality of fragments;
dividing, by the process, the corpus of one or more documents into a second plurality of fragments based on a second threshold size for a second large language model; and
computing, by the process, a second set of embeddings using the second large language model to analyze the second plurality of fragments; and
comparing a vector associated with queries to the first plurality of fragments and to the second plurality of fragments to determine vector similarity matches as part of providing responses to the queries,
wherein the responses to the queries according to the corpus of the one or more documents are based on an aggregation of i) the first plurality of fragments and the first set of embeddings, and ii) the second plurality of fragments and the second set of embeddings.

18. The apparatus of claim 17, wherein the responses to queries based on the corpus of one or more documents aggregate results from i) the first large language model using the first plurality of fragments and the first set of embeddings, and ii) the second large language model using the second plurality of fragments and the second set of embeddings.

19. The apparatus of claim 17, the process further comprising:
dividing the corpus of the one or more documents into the first plurality of fragments based further on semantic content associated with the corpus of the one or more documents; and
dividing the corpus of the one or more documents into the second plurality of fragments based further on the semantic content associated with the corpus of the one or more documents.

20. The apparatus of claim 17, the process further comprising:
dividing the corpus of the one or more documents into the first plurality of fragments based further on a syntax associated with the corpus of the one or more documents; and
dividing the corpus of the one or more documents into the second plurality of fragments based further on the syntax associated with the corpus of the one or more documents.

21. The method of claim 1, wherein determining the vector similarity matches includes utilizing at least one of cosine similarity, dot product, Euclidean distance, Manhattan distance, or Minkowski distance.
